(19) United States
(12) Patent Application Publication
(10) Pub. No.: US 2024/0054564 A1
(43) Pub. Date: Feb. 15, 2024

(54) METHOD AND PORTAL FOR COLLABORATIVE GOOD FAITH ESTIMATE OF HEALTHCARE COSTS

(71) Applicant: Healthcare TTU, Inc. d/b/a Hyve Healthcare, Centennial, CO (US)

(72) Inventors: Travis W. Gentry, Highlands Ranch, CO (US); Kari T. Kemper, Portland, OR (US); Dale R. Alexander, Montgomery, AL (US); Michael J. Cunningham, Littleton, CO (US); Tim A. Brenner, Portland, OR (US); Staci L. Meredith, Englewood, CO (US); Dana Sue Walsh, Owasso, OK (US)

(73) Assignee: Healthcare TTU, Inc. d/b/a Hyve Healthcare, Centennial, CO (US)

(21) Appl. No.: 18/131,574

(22) Filed: Apr. 6, 2023

Related U.S. Application Data
(60) Provisional application No. 63/396,406, filed on Aug. 9, 2022.

(51) Int. Cl. G06Q 40/08

(52) U.S. Cl. CPC G06Q 40/08

(57) ABSTRACT

A method as disclosed herein generates objective projections of aggregate costs from a plurality of providers associated with different aspects of a healthcare procedure. An interface is selectively initiated with a first provider associated with a patient and a respective healthcare procedure. A data module is established for the patient based on projected cost data for aspects associated with the first provider for the procedure. Respective interfaces are selectively initiated between further providers and the hosted platform, wherein each interface receives projected cost data for aspects associated with the respective provider for the procedure. Upon determining a threshold amount of cost data has been received for each of the different aspects of the procedure, the platform enables selective access by the patient to an aggregated cost projection for the procedure, based entirely on the input data received by the hosted platform for the respective healthcare procedure.

### CROSS-REFERENCES TO RELATED APPLICATIONS

The present application claims priority to and benefit from a U.S. provisional patent application filed on Aug. 9, 2022, identified as U.S. Appl. No. 63/396,406, and which is incorporated by reference in its entirety.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### FIELD OF THE DISCLOSURE

Various embodiments of an invention as disclosed herein relate generally to a collaborative portal where independent healthcare providers connect to generate objective projections of aggregate costs (e.g., Good Faith Estimate) for patients in accordance with, e.g., the No Surprises Act of the Consolidated Appropriations Act, codified as Section 2799B-6 of the Public Health Service Act, including all amendments thereto and the implementing regulations thereof.

### BACKGROUND

In the healthcare industry, providing patients with accurate, correct, complete, and reliable information regarding the patients' expected, anticipated, or imminent costs or expenses for medical services is critical. Effective as of January 2022, the No Surprises Act of the Consolidated Appropriations Act, codified as Section 2799B-6 of the Public Health Service Act (the “No Surprises Act”), protects consumers from surprise medical bills by prohibiting healthcare providers from billing patients for more than the in-network cost sharing amount for healthcare services. The No Surprises Act also established new protections and disclosure requirements for said expected, anticipated, or imminent costs or expenses for medical services. The No Surprises Act requires that healthcare practitioners (e.g., physicians), healthcare facilities (e.g., hospitals, ambulatory surgery centers (ASCs), outpatient clinics, laboratories, imaging centers), and ancillary providers (e.g., behavioral- or mental-health clinicians, occupational, physical, or speech therapists, and others) provide uninsured, out-of-network, or self-paying clients (i.e., patients) with a “good faith estimate” (or “GFE”) of the medical services. Notably, the scope of the No Surprises Act may (or is expected to) be expanded, such that healthcare practitioners, healthcare facilities, and ancillary providers will be required to provide good faith estimates to insured clients, whether the client is insured through a commercial payer, a health plan, or a government-backed program (e.g., Medicare and/or Medicaid).

The provision of a good faith estimate applies to a wide range of services, including (without limitation) medical encounters and procedures (and all other services related to a patient treatment cycle), medical testing (e.g., laboratory testing), medical supplies, and prescription drugs. No specific specialties, facility types, or sites of service are exempt from providing a good faith estimate, so the requirement broadly applies to any individuals who (i) schedule items or services, or (ii) request an estimate. The Department of Health and Human Services (HHS) has prescribed, by regulation, certain items of information that must be disclosed or listed on the good faith estimate: (i) patient name; (ii) patient date of birth; (iii) an itemization of medical services; (iv) codes for the medical services, including current procedural terminology (CPT) codes, diagnosis codes, and the costs per item of medical services; (v) name of the healthcare practitioner, healthcare facility, and/or ancillary providers delivering or facilitating the services; and (vi) disclaimers required by law.

While healthcare practitioners, healthcare facilities, and ancillary providers follow applicable law in generating and transmitting “good faith estimates,” such estimates are complicated by the dearth or scarcity of readily accessible data providing guidance on general or customary costs and/or expenses associated with the medical services, including ranges, means, and modes of the costs and/or expenses associated with said medical services. Not only is there a dearth or scarcity of information, but “good faith estimates” run the risk of falling prey to biases from healthcare practitioners, healthcare facilities, and/or ancillary providers, including (without limitation) assessments and/or determinations of effective treatment and/or pathology, patient-related acuities (e.g., patient allergies), and/or perceived or actual pre-existing conditions or co-morbidities. Moreover, “good faith estimates” are further complicated by the uncertainty of claim-submission and claim-remittance processes with third-party payors, wherein it is difficult to ascertain a present or future value (e.g., monetary amount) associated with then-standard coverage for the cost of medical services.

The No Surprises Act attempts to solve for some of the foregoing shortcomings by, for example, requiring providers to inquire with the patient, at the time of scheduling, as to whether there are any situations in which the individual expects his or her plan might not provide coverage for certain items or services. The average patient would likely be ill-informed and unable to predict or speculate on potential noncoverage, leaving the healthcare practitioner, healthcare facility, or ancillary provider with uncertainty as to quantifying or projecting a good faith estimate. But while the No Surprises Act attempts to provide a solution to the shortcomings described above, convening providers have incurred increased responsibility for generating and presenting good faith estimates to a patient. A “convening provider” is a healthcare practitioner, healthcare facility, or ancillary provider who (or that) is responsible for scheduling a primary medical service or item. Often, for certain medical services (e.g., surgical procedures), other providers, such as co-providers (e.g., healthcare practitioner, healthcare facility, or ancillary provider) must provide related services (e.g., anesthesiology, radiology). Because co-providers are generally outside of the convening provider's organization, convening providers are unable to exercise control over co-providers, thereby making efforts to generate a good faith estimate more challenging. The burden on convening providers is further enhanced by regulatory-imposed timeframes, often requiring the convening provider to respond to patients' requests for good faith estimates within twenty-four (24) to seventy-two (72) hours.

An important aspect for generating a good faith estimate for healthcare practitioners, healthcare facilities, and ancillary providers, on behalf of their respective patients, is the ability to project costs associated with the medical services, or other aspects related to the medical services. Such ability to project costs is especially enhanced where the cost projection is provided or otherwise made in accordance with input queries to a third-party hosted system. Another important aspect for hosting a platform capable of generating cost projections for good faith estimates is to provide healthcare practitioners, healthcare facilities, and ancillary providers with readily accessible data concerning industry-standard, or industry-nonconventional, costs of medical services for patients receiving certain medical services. Conventional mechanisms, however, lack such cost projection means or are otherwise unable to provide the aforementioned features for other reasons.

### BRIEF SUMMARY

The present disclosure addresses the problems identified above, amongst others. Implementations consistent with the present disclosure provide systems, apparatuses, and methods for generating projections of costs for one or more healthcare providers, on behalf of their respective patients. The one or more healthcare providers may encompass a convening provider and one or more co-providers, and the one or more healthcare providers may include healthcare practitioners (e.g., physicians), healthcare facilities (e.g., hospitals, ambulatory surgery centers (ASCs), outpatient clinics, laboratories, imaging centers), and ancillary providers (e.g., behavioral—or mental-health clinicians, occupational, physical, or speech therapists, and others). In the context of the No Surprises Act, a healthcare provider is required to provide a patient with a good faith estimate of the cost of certain medical services (e.g., healthcare procedure), along with different aspects associated with said certain medical services. Conventional ways of analyzing the good faith estimate of the cost of said certain medical services is to provide then-current itemized rates or costs associated with the medical services; such then-current itemized rates or costs may be derived from prior services performed by the healthcare provider, or other internally archived historical itemizations.

In contrast, an exemplary host platform and cost-projection methodology, as disclosed herein, may receive input data pertaining to a patient's healthcare procedure, which may include a projected cost estimate. Other data, provided by third-party healthcare providers, may provide data corresponding to the patient's healthcare procedure, such that it may be determined whether a sufficient or adequate amount of cost data can reliably or accurately provide an aggregated cost projection of the patient's healthcare procedure, which is objective in nature. In the exemplary host platform, healthcare providers, including a convening provider and one or more co-providers, may collaborate with one another to generate and transmit a collective, centralized good faith estimate for a patient. The convening provider may, for example, invite the one or more co-providers into a hosted platform (e.g., a portal), wherein each of the convening provider and the one or more co-providers may input data associated with an estimate for an item or medical service. Such hosted platform may be agnostic to then-existing electronic health records (EHR) systems associated with the healthcare providers, practice-management systems, and other technologies.

In a particular embodiment, a computer-implemented method is disclosed herein for generating objective projections of aggregate costs from a plurality of providers associated with different aspects of a healthcare procedure. The method may include selectively initiating an interface between a hosted platform and a first healthcare provider associated with a patient and a respective healthcare procedure, wherein the hosted platform comprises data storage configured to store at least cost data corresponding to different aspects for each of a plurality of healthcare procedures including a type of healthcare procedure corresponding to the respective healthcare procedure. The method may further include establishing a data module for the patient in the data storage, based at least in part on input data provided via the selectively initiated interface, wherein the input data comprises projected cost data for at least one aspect associated with the first healthcare provider for the respective healthcare procedure. The method may further include selectively initiating respective interfaces between one or more further healthcare providers and the hosted platform, wherein each respective interface with the one or more further healthcare providers is configured to receive input data comprising projected cost data for at least one aspect associated with the respective healthcare provider for the respective healthcare procedure. Upon determining that a threshold amount of cost data has been received via the interfaces for each of the different aspects of the respective healthcare procedure, the method may further include generating a message to the patient enabling selective access to an aggregated cost projection for the respective healthcare procedure, wherein the aggregated cost projection is based entirely on the input data received by the hosted platform for the respective healthcare procedure.

In one further exemplary feature according to the above-referenced embodiment, the one or more further healthcare providers may be invited via the hosted platform to establish respective interfaces with the hosted platform pursuant to selection by the first healthcare provider.

The selection by the first healthcare provider of at least one of the one or more further healthcare providers may for example be enabled via a user interface tool selectively displaying a plurality of healthcare providers having stored relationships in the data storage associated with respective aspects of the respective healthcare procedure.

In another further exemplary feature according to the above-referenced embodiment, at least one of the one or more further healthcare providers may be invited to establish respective interfaces with the hosted platform pursuant to programmatic selection by the hosted platform based on predetermined relationships between the at least one of the one or more further healthcare providers and the at least one aspect for the respective healthcare procedure.

In another further exemplary feature according to the above-referenced embodiment, at least one of the one or more further healthcare providers may be invited to establish respective interfaces with the hosted platform pursuant to programmatic selection by the hosted platform based on predetermined relationships between the at least one of the one or more further healthcare providers and previous healthcare procedures performed with respect to the patient.

In another further exemplary feature according to the above-referenced embodiment, the interface between the hosted platform and the first healthcare provider may be selectively initiated pursuant to input from the patient.

In another further exemplary feature according to the above-referenced embodiment, the interface between the hosted platform and the first healthcare provider may be selectively initiated pursuant to input from the first healthcare provider.

For example, the input from the first healthcare provider for initiating the interface may comprise a response to a push notification generated by the hosted platform pursuant to input from the patient.

In another further exemplary feature according to the above-referenced embodiment, at least one aspect stored in the data storage in association with the respective healthcare procedure is generated based at least in part on insurance input received by the hosted platform.

Another further exemplary feature according to the above-referenced embodiment may comprise programmatic review of the projected cost data and of historical cost data stored in the data storage with respect to the corresponding aspects of the respective healthcare procedure, and identifying any discrepancies between the projected cost data and the historical cost data greater than a predetermined threshold value.

Another further exemplary feature according to the above-referenced embodiment may comprise, upon identifying said discrepancies and prior to determining that a threshold amount of cost data has been received for each of the different aspects of the respective healthcare procedure, generating a message requesting confirmation, correction, and/or exclusion of at least part of the projected cost data corresponding to the identified discrepancies.

The projected cost data received from the one or more further healthcare providers may be identified at the hosted platform with respect to at least patient access.

In another further exemplary feature according to the above-referenced embodiment, at least one interface with the one or more further healthcare providers may be configured to receive the input data comprising projected cost data by enabling entry of the input data by the respective further healthcare providers.

In another further exemplary feature according to the above-referenced embodiment, at least one interface with the one or more further healthcare providers may be configured to receive input data comprising projected cost data by extracting historical cost data corresponding to the at least one aspect associated with the respective healthcare provider for the respective healthcare procedure.

For example, the historical cost data may be extracted from a remote database if available with respect to the respective further healthcare provider, and otherwise an interface may be generated to receive the input data by requesting data entry by the respective further healthcare provider.

In another embodiment as disclosed herein, a hosted platform may be provided for generating objective projections of aggregate costs from a plurality of providers associated with different aspects of a healthcare procedure. The hosted platform is communicatively coupled to one or more client computing devices via a communications network comprising gateway modules. At least one of the one or more client computing devices is associated with a first healthcare provider, the first healthcare provider being associated with a patient and a respective healthcare procedure. And, another of the one or more client computing devices is associated with one or more further healthcare providers. The hosted platform comprises one or more non-transitory computer readable media. The one or more non-transitory computer readable media is configured to store at least cost data corresponding to different aspects for each of a plurality of healthcare procedures including a type of healthcare procedure, and the one or more non-transitory computer readable media has program instructions residing thereon and executable by processors associated with the hosted platform to direct performance of operations according to the above-referenced method embodiment and optionally any one or more of the related aspects.

In another particular embodiment, a method as disclosed herein is provided for generating objective projections of aggregate costs from a plurality of providers associated with different aspects of a healthcare procedure. The method commences with providing, via a selectively initiated interface between a hosted platform and a first healthcare provider associated with a patient and a respective healthcare procedure, input data to a data module established in a data storage of the hosted platform, the data storage configured to store at least cost data corresponding to different aspects for each of a plurality of healthcare procedures including a type of healthcare procedure corresponding to the respective healthcare procedure. The method continues with forming a first input data set in a first data structure based upon the input data provided to the data module, the input data comprising projected cost data for at least one aspect associated with the first healthcare provider for the respective healthcare procedure. The method continues by further forming one or more further input data sets in respective one or more data structures, the one or more further data sets comprising historical cost data corresponding to the different aspects for each of the plurality of healthcare procedures including the type of healthcare procedure corresponding to the respective healthcare procedure, the historical data residing on the data module established in the data storage of the hosted platform. The method continues with mapping the first data structure against the respective one or more data structures to yield an aggregated cost projection for the respective healthcare procedure. And upon determining that a threshold amount of cost data has been mapped for each of the different aspects of the respective healthcare procedure, the method continues with generating a message to the patient enabling selective access to the aggregated cost projection for the respective healthcare procedure.

Unless otherwise defined, all technical and scientific terms used herein have the same meaning as commonly understood by one of ordinary skill in the art to which this disclosure belongs. The present disclosure may be embodied in other specific forms without departing from the spirit or essential attributes thereof, and it is therefore desired that the present embodiment be considered in all aspects as illustrative and not restrictive. Any headings utilized in the description are for convenience only and no legal or limiting effect. Numerous objects, features, and advantages of the embodiments set forth herein will be readily apparent to those skilled in the art upon reading of the following disclosure when taken in conjunction with the accompanying drawings.

### BRIEF DESCRIPTION OF THE DRAWINGS

Hereinafter, various exemplary embodiments of the disclosure are illustrated in more detail with reference to the drawings.

FIG. 1 is a block diagram illustrating an exemplary embodiment of a network for providing a system according to aspects of the present disclosure.

FIG. 2 is a flowchart illustrating an exemplary embodiment of a method according to aspects of the present disclosure.

### DETAILED DESCRIPTION

Reference will now be made in detail to embodiments of the present disclosure, one or more drawings of which are set forth herein. Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

While the making and using of various embodiments of the present disclosure are discussed in detail below, it should be appreciated that the present disclosure provides many applicable inventive concepts that can be embodied in a wide variety of specific contexts. The specific embodiments discussed herein are merely illustrative of specific ways to make and use the invention and do not delimit the scope of the disclosure.

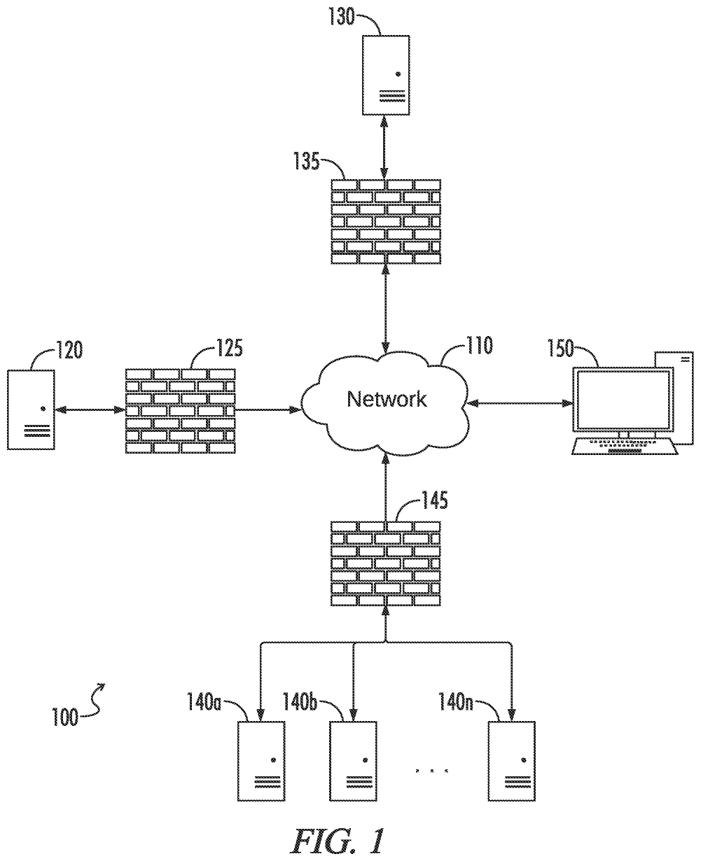

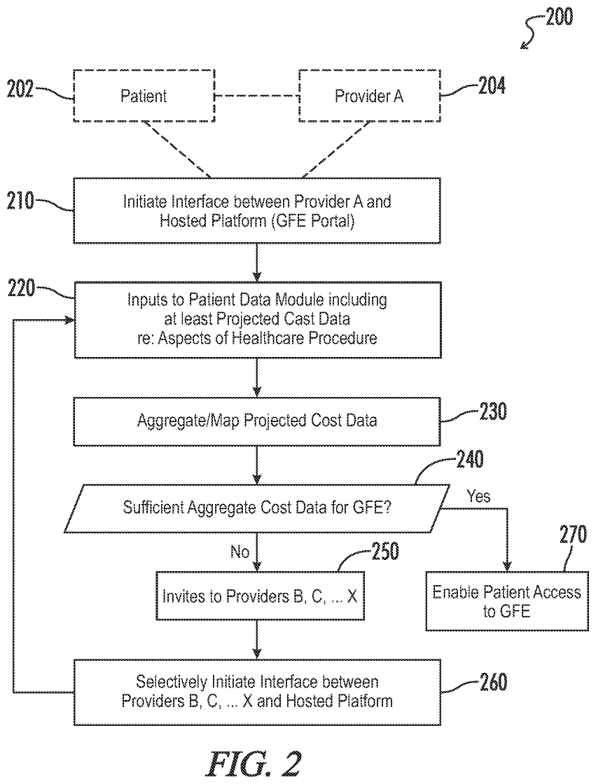

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure. Referring generally to FIGS. 1 and 2, various exemplary embodiments the present disclosure may now be described in detail. Where the various figures may describe embodiments sharing various common elements and features with other embodiments, similar elements and features are given the same reference numerals and redundant description thereof may be omitted below.

As shown in FIG. 1, provided is an exemplary embodiment of a system 100 including a portal for coordinating communications and data exchange among a plurality of participants according to aspects of the present disclosure. The system 100 as shown includes a network 110 capable of being coupled to one or more other computing elements. In one exemplary embodiment, the network 110 includes the Internet, a public network, a private network, or any other communications medium capable of conveying electronic communications. The system 100 may further include a client (e.g., health system) computing device 120 associated, for example, with a primary healthcare provider, such as a convening provider, a host computing device 130, one or more further computing elements 140 associated, for example, with respective further (secondary) healthcare providers (such as co-providers, co-facilities, etc.), and/or a user device 150 associated, for example, with a patient. For the purpose of the disclosure, the primary healthcare provider, which may be associated with the client computing device 120, and/or the secondary healthcare providers, which may be associated with the one or more further computing elements 140, may include healthcare practitioners (e.g., physicians), healthcare facilities (e.g., hospitals, ambulatory surgery centers (ASCs), outpatient clinics, laboratories, imaging centers), and ancillary providers (e.g., behavioral- or mental-health clinicians, occupational, physical, or speech therapists, and others).

Communication between a communication module (not illustrated) of the client computing device 120 and the network 110 is configured to be performed by wired interface, wireless interface, or a combination thereof, without departing from the spirit and the scope of the present disclosure. At least one firewall 125 may be interposed between the network 110 and client computing device 120. In one exemplary operation, the client computing device 120 is configured to store one or more sets of instructions in a storage coupled thereto or otherwise capable of being communicatively coupled to the client computing device 120. The one or more sets of instructions may be configured to be executed by a hardware and/or software processor of the client computing device 120 to perform one or more operations corresponding to the one or more sets of instructions.

In various exemplary embodiments, the client computing device 120 may be implemented as at least one of a server computer, a server device, a desktop computer, a laptop computer, a smart phone, or any other electronic device capable of executing instructions. The microprocessor of the client computing device 120 may be a generic hardware processor, a special-purpose hardware processor, or a combination thereof. In embodiments having a generic hardware processor (e.g., as a central processing unit (CPU) available from manufacturers such as Intel and/or AMD), the generic hardware processor may be configured to be converted to a special-purpose processor by means of being programmed to execute and/or by executing a particular algorithm in the manner discussed herein for providing a specific operation or result.

The client computing device 120 is configured in various embodiments to operate remotely and may be configured to obtain or otherwise operate upon one or more instructions stored physically remote from the client computing device 120 (e.g., via client-server communications and/or cloud-based computing).

The system 100 may further include the host computing device 130 coupleable to the network 110. Communication between a communication module (not illustrated) of the host computing device 130 and the network 110 is configured to be performed by wired interface, wireless interface, or a combination thereof, without departing from the spirit and the scope of the present disclosure. At least one firewall 135 may be interposed between the network 110 and the host computing device 130. In one exemplary operation, the host computing device 130 is configured to store one or more sets of instructions in a storage coupled thereto or otherwise capable of being communicatively coupled to the host computing device 130. The one or more sets of instructions may be configured to be executed by a hardware and/or software processor of the host computing device 130 to perform one or more operations corresponding to the one or more sets of instructions.

In various exemplary embodiments, the host computing device 130 may be implemented as at least one of a server computer, a server device, a desktop computer, a laptop computer, a smart phone, or any other electronic device capable of executing instructions. The microprocessor of the host computing device 130 may be a generic hardware processor, a special-purpose hardware processor, or a combination thereof. In embodiments having a generic hardware processor (e.g., as a central processing unit (CPU) available from manufacturers such as Intel and/or AMD), the generic hardware processor may be configured to be converted to a special-purpose processor by means of being programmed to execute and/or by executing a particular algorithm in the manner discussed herein for providing a specific operation or result.

The host computing device 130 is configured in various embodiments to operate remotely and may be configured to obtain or otherwise operate upon one or more instructions stored physically remote from the host computing device 130 (e.g., via client-server communications and/or cloud-based computing).

At least one further participant such as secondary provider or facility devices 140a, 140b, . . . , 140n may be coupled or otherwise configured for coupling to the network 110. In other embodiments, other devices 140a, 140b, . . . , 140n may comprise devices associated with third-party vendors for billing (or related aspects, such as revenue cycle management and healthcare clearinghouses) or various payers (e.g., private insurer, health plan, and/or governmental program, such as Medicare/Medicaid), and said devices 140a, 140b, . . . , 140n may be coupled or otherwise configured for coupling to the network 110, such as when, for example, a patient (e.g., Patient 202) desires to tender payment in connection with the generated good faith estimate. One or more secondary device 140 may be configured to store one or more sets of data or information usable according to aspects of the present disclosure, for example as described herein with reference to FIG. 2. Communication between a communication module (not illustrated) of the one or more secondary device 140 and the network 110 is configured to be performed by wired interface, wireless interface, or a combination thereof, without departing from the spirit and the scope of the present disclosure. In one exemplary operation, the one or more secondary device 140 is configured to store one or more sets of instructions in a storage coupled thereto or otherwise capable of being communicatively coupled to the one or more secondary device 140. The one or more sets of instructions may be configured to be executed by a hardware and/or software processor of the one or more secondary device 140 to perform one or more operations corresponding to the one or more sets of instructions.

In various exemplary embodiments, the one or more secondary device 140 may be implemented as at least one of a server computer, a server device, a desktop computer, a laptop computer, a smart phone, or any other electronic device capable of executing instructions. The microprocessor of the one or more secondary device 140 may be a generic hardware processor, a special-purpose hardware processor, or a combination thereof. In embodiments having a generic hardware processor (e.g., as a central processing unit (CPU) available from manufacturers such as Intel and/or AMD), the generic hardware processor may be configured to be converted to a special-purpose processor by means of being programmed to execute and/or by executing a particular algorithm in the manner discussed herein for providing a specific operation or result.

The one or more secondary device 140 is configured in various embodiments to operate remotely and may be configured to obtain or otherwise operate upon one or more instructions stored physically remote from the one or more secondary device 140 (e.g., via client-server communications and/or cloud-based computing).

At least one patient user device 150 may be coupled or otherwise configured for coupling to the network 110. One or more user device 150 may be configured to store one or more sets of data or information usable according to aspects of the present disclosure, for example as described herein with reference to FIG. 2. Communication between a communication module (not illustrated) of the at least one user device 150 and the network 110 is configured to be performed by wired interface, wireless interface, or a combination thereof, without departing from the spirit and the scope of the present disclosure. In one exemplary operation, the at least one user device 150 is configured to store one or more sets of instructions in a storage coupled thereto or otherwise capable of being communicatively coupled to the at least one user device 150. The one or more sets of instructions may be configured to be executed by a hardware and/or software processor of the at least one user device 150 to perform one or more operations corresponding to the one or more sets of instructions.

In various exemplary embodiments, the at least one user device 150 may be implemented as at least one of a server computer, a server device, a desktop computer, a laptop computer, a smart phone, or any other electronic device capable of executing instructions. The microprocessor of the at least one user device 150 may be a generic hardware processor, a special-purpose hardware processor, or a combination thereof. In embodiments having a generic hardware processor (e.g., as a central processing unit (CPU) available from manufacturers such as Intel and/or AMD), the generic hardware processor may be configured to be converted to a special-purpose processor by means of being programmed to execute and/or by executing a particular algorithm in the manner discussed herein for providing a specific operation or result.

The at least one user device 150 is configured in various embodiments to operate remotely and may be configured to obtain or otherwise operate upon one or more instructions stored physically remote from the at least one user device 150 (e.g., via client-server communications and/or cloud-based computing).

An exemplary embodiment of a method 200 as disclosed herein may now be described with further illustrative reference to FIG. 2. While the method 200 may be described with reference to elements of the system 100 as noted above, the various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps may be described generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The steps or algorithms of the method 200 as described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable medium known in the art. An exemplary computer-readable medium can be coupled to the processor such that the processor can read information from, and write information to, the memory/storage medium. In the alternative, the medium can be integral to the processor. The processor and the medium can reside in an ASIC. The ASIC can reside in a user terminal. In the alternative, the processor and the medium can reside as discrete components in a user terminal.

The method 200 in an embodiment as disclosed herein may relate generally to the generation of objective projections of aggregate costs from a plurality of providers associated with different aspects of a healthcare procedure. Such objective projections may for example themselves relate to good faith estimates of aggregate costs for a healthcare procedure, and a hosted platform also as described herein may further be described in certain embodiments as a “good faith estimate” (or “GFE”) portal.

The method 200 may include selectively initiating an interface between a hosted platform (e.g., device 130) and a first healthcare provider, such as Provider A 204 (e.g., via client device 120), associated with a patient (e.g., patient 202) and a respective healthcare procedure (step 210). The hosted platform may include a network 110, or certain portions of a network 110, as shown in FIG. 1 or may include one or more servers 130 coupled to the network, or other combinations as effective to link to the various entities shown and further described herein.

In an embodiment, initiation of the interface between the hosted platform and the first healthcare provider, such as Provider A 204, may be performed responsive to a request from the first healthcare provider. Alternatively, the patient may submit a request to the hosted platform for initiating the interface, in which case a message may be sent from the hosted platform to the first healthcare provider enabling initiation of the interface via for example selection of a link embedded therein. The first healthcare provider may for example have an account associated with the hosted platform, wherein the invitation of or by the first healthcare provider may be streamlined accordingly, or alternatively the first healthcare provider may be invited to form an account with the hosted platform prior to initiation of the interface for further data exchange. The interface may be generated in the context of an application resident on a device associated with the first healthcare provider, such as the client device 120, or alternatively the interface may be generated via a browser-based context.

The hosted platform may include a data storage such as for example a hosted database, or otherwise be functionally linked to data storage residing on third party servers, cloud servers, or the like, and which may store at least cost data corresponding to different aspects for each of a plurality of healthcare procedures including a type of healthcare procedure corresponding to the healthcare procedure for the patient. For example, the data storage may include historical cost data relating to similar healthcare procedures for the purpose of comparison to aggregate projected cost data as further described below. The data storage may also include a list of aspects such as required, expected, and or optional healthcare services associated with the various types of healthcare procedures. The data storage may further include procedural codes (e.g., current procedural terminology (CPT) codes) or descriptions (or variations of said descriptions) of the various types of healthcare procedures. In an embodiment, the hosted platform may include a learning model which at least periodically reviews the stored data regarding historical costs for analysis against healthcare outcomes for the purpose of for example correlating the aggregate costs of a healthcare procedure with desirable (and/or undesirable) outcomes thereof. Such embodiments may involve forming first input data sets in a first data structure for use in a learning model and further input data sets in respective data structure relating specifically to a type of healthcare procedure, a healthcare provider (individual, facility, etc.), a patient, or the like, wherein at least the first data structure may for example be populated with deidentified data for the purpose of model improvement but without the ability to identify the sources of the underlying data. In other optional embodiments, the learning model may at least periodically review the stored data regarding historical costs for analysis, where such historical costs may be further categorized, classified, or compartmentalized into aspects related to the aggregate cost of the healthcare procedure, such aspects including cost data for a particular geographic territory or area, cost data for a particular specialty (or sub-specialty) of practice, cost data for a specified healthcare provider (e.g., the first healthcare provider, such as Provider A), or cost data for secondary healthcare providers (e.g., co-providers).

The method 200 may further include establishing a data module for the patient in the data storage, based on or supplemented by input data provided by the first healthcare provider via the selectively initiated interface (e.g., in step 220). The input data may for example define a healthcare procedure to be performed, aspects of the healthcare procedure to be performed and requiring projected cost data, projected cost data for at least one aspect associated with or otherwise to be performed by the first healthcare provider, and the like. In an embodiment, input data associated with the patient and/or the healthcare procedure and relevant to the projection of cost data may be provided from an insurance provider and stored in the data module. In another embodiment, the input data may, for example, define other aspects of the healthcare procedure to be performed, including general or specific descriptions of the procedure (and/or other medical services or items), estimation identification information, such as information deriving from a health information system (HIS), diagnosis/es codes, and procedure- and/or item-related codes, such as current procedural terminology (CPT) codes. In yet other embodiments, the input data may, for example, constitute projected cost data from a then-current fee schedule, the fee schedule of which may be provided from an insurance provider or the first healthcare provider, and stored in the data module.

The projected cost data received in step 220 may preferably be mapped in data storage (e.g., in a data module set up for the patient and in association with the requested good faith estimate) against specified aspects of the healthcare procedure at issue (step 230). The hosted platform can accordingly determine (in step 240) whether a sufficient amount of aggregated cost data has been provided to complete a good faith estimate. This determination may be made in accordance with predetermined rules, for example wherein projected cost data has been received from at least one source for each aspect associated with the healthcare procedure. In another example, the hosted platform may require a specified amount of projected cost data inputs greater than one for some or all of the different aspects, or may only require projected cost data for a certain number of the aspects associated with the healthcare procedure, wherein for example some of the aspects may be reliably projected based on historical data or otherwise are unnecessary for completing the good faith estimate.

If the current amount of projected cost data is deemed insufficient to complete the good faith estimate (i.e., “no” in reply to the query from step 240), the method 200 may further include generating invitations to additional healthcare providers such as for example co-providers, co-facilities, or the like (step 250) and selectively initiating respective interfaces between one or more of the additional healthcare providers and the hosted platform (step 260). Though, in other embodiments, where the current amount of projected cost data is not deemed sufficient to complete the good faith estimate, the method 200 may enable selective access to a partially aggregated cost projection for the respective healthcare procedure (step 270), wherein the partially aggregated cost projection is based entirely on the input data received by the hosted platform for the respective healthcare procedure. Where invitations are generated to additional healthcare providers (step 250), some or all of the additional healthcare providers may be selected in an embodiment by the first (primary) healthcare provider, for example as part of the input data as described above, wherein the invitations are extended by the hosted platform to the additional healthcare providers. The selection by the first healthcare provider of at least one of the one or more further healthcare providers may for example be enabled or otherwise facilitated via a user interface tool selectively displaying a plurality of healthcare providers having stored relationships in the data storage associated with respective aspects of the respective healthcare procedure.

The invitations may in an embodiment be directed to a type of healthcare procedure or aspect thereof, without specifically describing the healthcare procedure or aspect thereof associated with the patient. The invitations may further or alternatively be deidentified with respect to the primary healthcare provider. However, the scope of the present disclosure also encompasses embodiments where the invitations include information regarding the primary healthcare provider, the patient, and/or the healthcare procedure at issue, and in an embodiment the first healthcare provider may even send the invitations directly to one or more of the additional healthcare providers for the purpose of soliciting projected cost data.

In an embodiment, some or all of the additional healthcare providers may be invited by the hosted platform to establish respective interfaces with the hosted platform, directly from the hosted platform or otherwise stated without selection by the patient or the primary healthcare provider. Such selection may be programmatic in nature, based for example on predetermined relationships between a certain additional healthcare provider and the patient and/or the primary healthcare provider, and/or proximity to a location of the healthcare procedure, and/or historical information resulting in a determined recommendation by the hosted platform with respect to at least one aspect of the healthcare procedure, and/or a relationship between the additional healthcare provider and other additional healthcare providers already selected for other aspects of the respective healthcare procedure, etc.

Accordingly, each respective interface with the one or more additional healthcare providers is configured to receive input data (e.g., returning to step 220) comprising projected cost data for at least one aspect associated with the respective healthcare provider for the respective healthcare procedure. In various embodiments (not explicitly shown in FIG. 2), further feedback may be required, requested, or otherwise enabled from the primary healthcare provider with respect to input data provided from one or more of the further healthcare providers. For example, a request may be sent for the primary healthcare provider to approve an otherwise completed good faith estimate based at least in part on inputs from other healthcare providers before providing access to the patient. As another example, the primary healthcare provider may be selectively notified for optional feedback based on flagged input data from one or more of the other healthcare providers as being potentially problematic (e.g., out of an expected range of inputs), or where for example the one or more of the other healthcare providers are providing input data in a particular field that overlaps with the primary healthcare provider or otherwise that may have previously been flagged by the primary healthcare provider as one in which additional review and optional feedback is requested.

Upon determining that a threshold amount of projected cost data has been received via the interfaces for each of the different aspects of the respective healthcare procedure (i.e., “yes” in reply to the query in step 240), the method may further include generating a message to the patient enabling selective access to an aggregated cost projection for the respective healthcare procedure (step 270), wherein the aggregated cost projection is based entirely on the input data received by the hosted platform for respective healthcare procedure.

In an embodiment, the determination of whether sufficient aggregate cost data has been received (i.e., in step 240) may further include a programmatic review of the aggregated projected cost data and of historical cost data stored in the data storage with respect to the corresponding aspects of the respective healthcare procedure, wherein the hosted platform may be programmed to identify any meaningful discrepancies between the projected cost data and the historical cost data. For example, the hosted platform may be programmed to reject projected cost data received from a healthcare provider that results in a discrepancy greater than a predetermined threshold value with respect to historical cost data. The historical cost data may for example relate to the type of procedure, similar procedures performed with respect to the same patient, a location of the procedure, similar procedures performed by the same healthcare provider, etc. In various embodiments (not explicitly shown in FIG. 2), further feedback may be required, requested, or otherwise enabled at this stage from the primary healthcare provider with respect to input data provided from one or more of the further healthcare providers, as described above with respect to the subsequent iterations of step 220 but in place of or in addition to such feedback.

In generating a good faith estimate, the hosted platform may in some embodiments generate an average value with respect to one or more projected cost data inputs for each aspect defined for the healthcare procedure at issue. Alternatively, the hosted platform may only accept projected cost data within a defined range of an initially specified cost value for a given aspect, such as for example may be based on historical data as otherwise described herein, wherein an average value of the accepted or otherwise filtered projected cost data is applied. In an embodiment, the method may include generating a first good faith estimate and then forwarding the first good faith estimate for review by a disinterested entity, wherein some or all of the projected cost data may be removed from the calculations in a subsequent iteration of the process.

In an embodiment, the hosted platform may further, upon identifying said discrepancies and prior to determining that a threshold amount of cost data has been received for each of the different aspects of the respective healthcare procedure, and rather than simply rejecting the projected cost data as described above, instead generate a message to the healthcare provider as the source of the projected cost data at issue requesting confirmation, correction, and/or exclusion of at least part of the projected cost data corresponding to the identified discrepancies.

In other optional embodiments, where the interface between the hosted platform and the first healthcare provider is selectively initiated pursuant to input from the patient or from the first healthcare provider, the hosted platform may generate a message or an alert to the first healthcare provider (e.g., Provider A) associated with the patient (i.e., Patient 202), and to secondary healthcare providers associated with other aspects of a healthcare procedure, the message or alert containing information on relative priority associated with the timeliness of transmitting the good faith estimate to the patient. For example, the message or alert may contain information on relative priority, as broken down into several categories, the categories being (among otherings) high priority (e.g., less than twenty-four hours to comply with regulatory requirements), low priority (e.g., more than twenty-four hours to comply with regulatory requirements), and overdue (e.g., beyond the period of time to comply with regulatory requirements).

In an embodiment, the generated message for the patient (step 270) may be presented in a manner that comports with applicable federal law and the implementing regulations, including (without limitation) 45 C.F.R. § 149.610(b)(1)(iii) and 45 C.F.R. § 149.610(e)(1). For example, the generated message may be provided in written form in an electronic medium, which may be displayable on the user device 150 and/or accessible on the hosted platform. The hosted platform may also enable the healthcare provider, and/or the healthcare provider's patient, to render the generated message into printable form, to the extent the patient requests this method of delivery. All in all, the generated messages provided electronically, by and through the hosted platform, may be provided in a manner that the patient may save the generated message (e.g., onto a storage of the user device 150) or print the generated message (e.g., by and through use of or access to the user device 150). And, the generated messages may be presented to the patient using clear and understandable language, in a manner calculated to be understood by an average person.

In the context of the present disclosure, apparatuses and systems (e.g., the system 100) and methods (e.g., the method 200) may relate generally to the generation of objective projections of aggregate costs from a plurality of providers associated with different aspects of a healthcare procedure. An exemplary host platform (via host computing device 130), bolsters the efficiency of generating and transmitting a good faith estimate from a healthcare provider to the healthcare provider's patients. Rather than initiate cumbersome communications via conventional methods of communication (e.g., telephonic communication or electronic mail), the hosted platform provides a centralized portal from which the primary healthcare provider (and secondary healthcare providers) can manage the preparation of good faith estimations, managing relative priorities and escalating notification to ensure compliance with prevailing applicable law. The hosted platform additionally imposes accountability on the primary healthcare provider, and the secondary healthcare providers, so as to ensure the patients are receiving the aggregated cost projections for the good faith estimate, in a manner that comports with the timing requirements of prevailing applicable law. And further, the hosted platform, through its user-initiated interfaces, and the data modules residing on data storage, provides the primary healthcare providers, secondary healthcare providers, the patient, and other relevant third parties (e.g., governmental entities) with visibility on the generation of the projected aggregated cost of the good faith estimate. Such visibility may enable seamless auditability of the hosted platform.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may. As used herein, the phrase “one or more of,” when used with a list of items, means that different combinations of one or more of the items may be used and only one of each item in the list may be needed. For example, “one or more of” item A, item B, and item C may include, for example, without limitation, item A or item A and item B. This example also may include item A, item B, and item C, or item Band item C.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. The conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The previous detailed description has been provided for the purposes of illustration and description. Thus, although there have been described particular embodiments of a new and useful invention, it is not intended that such references be construed as limitations upon the scope of this invention except as set forth in the following claims. Thus, it is seen that the apparatus, methods, and/or systems of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims.

What is claimed is:

1. A computer-implemented method for generating objective projections of aggregate costs from a plurality of providers associated with different aspects of a healthcare procedure, the method comprising:
selectively initiating an interface between a hosted platform and a first healthcare provider associated with a patient and a respective healthcare procedure, wherein the hosted platform comprises data storage configured to store at least cost data corresponding to different aspects for each of a plurality of healthcare procedures including a type of healthcare procedure corresponding to the respective healthcare procedure;
establishing a data module for the patient in the data storage, based at least in part on input data provided via the selectively initiated interface, wherein the input data comprises projected cost data for at least one aspect associated with the first healthcare provider for the respective healthcare procedure;
selectively initiating respective interfaces between one or more further healthcare providers and the hosted platform, wherein each respective interface with the one or more further healthcare providers is configured to receive input data comprising projected cost data for at least one aspect associated with the respective healthcare provider for the respective healthcare procedure; and
upon determining that a threshold amount of cost data has been received via the interfaces for each of the different aspects of the respective healthcare procedure, generating a message to the patient enabling selective access to an aggregated cost projection for the respective healthcare procedure, wherein the aggregated cost projection is based entirely on the input data received by the hosted platform for the respective healthcare procedure.

2. The method of claim 1, wherein the one or more further healthcare providers are invited via the hosted platform to establish respective interfaces with the hosted platform pursuant to selection by the first healthcare provider.

3. The method of claim 2, wherein the selection by the first healthcare provider of at least one of the one or more further healthcare providers is enabled via a user interface tool selectively displaying a plurality of healthcare providers having stored relationships in the data storage associated with respective aspects of the respective healthcare procedure.

4. The method of claim 1, wherein at least one of the one or more further healthcare providers are invited to establish respective interfaces with the hosted platform pursuant to programmatic selection by the hosted platform based on predetermined relationships between the at least one of the one or more further healthcare providers and the at least one aspect for the respective healthcare procedure.

5. The method of claim 1, wherein at least one of the one or more further healthcare providers are invited to establish respective interfaces with the hosted platform pursuant to programmatic selection by the hosted platform based on predetermined relationships between the at least one of the one or more further healthcare providers and previous healthcare procedures performed with respect to the patient.

6. The method of claim 1, wherein the interface between the hosted platform and the first healthcare provider is selectively initiated pursuant to input from the patient.

7. The method of claim 1, wherein the interface between the hosted platform and the first healthcare provider is selectively initiated pursuant to input from the first healthcare provider.

8. The method of claim 7, wherein the input from the first healthcare provider for initiating the interface comprises a response to a push notification generated by the hosted platform pursuant to input from the patient.

9. The method of claim 1, wherein at least one aspect stored in the data storage in association with the respective healthcare procedure is generated based at least in part on insurance input received by the hosted platform.

10. The method of claim 1, further comprising programmatic review of the projected cost data and of historical cost data stored in the data storage with respect to the corresponding aspects of the respective healthcare procedure, and identifying any discrepancies between the projected cost data and the historical cost data greater than a predetermined threshold value.

11. The method of claim 10, further comprising, upon identifying said discrepancies and prior to determining that a threshold amount of cost data has been received for each of the different aspects of the respective healthcare procedure, generating a message requesting confirmation, correction, and/or exclusion of at least part of the projected cost data corresponding to the identified discrepancies.

12. The method of claim 1, wherein at least one interface with the one or more further healthcare providers is configured to receive the input data comprising projected cost data by enabling entry of the input data by the respective further healthcare providers.

13. The method of claim 1, wherein at least one interface with the one or more further healthcare providers is configured to receive input data comprising projected cost data by extracting historical cost data corresponding to the at least one aspect associated with the respective healthcare provider for the respective healthcare procedure.

14. The method of claim 13, wherein the historical cost data is extracted from a remote database if available with respect to the respective further healthcare provider, and otherwise an interface is generated to receive the input data by requesting data entry by the respective further healthcare provider.

15. A hosted platform for generating objective projections of aggregate costs from a plurality of providers associated with different aspects of a healthcare procedure, the hosted platform communicatively coupled to one or more client computing devices via a communications network comprising gateway modules, wherein the hosted platform comprises one or more non-transitory computer readable media configured to store at least cost data corresponding to different aspects for each of a plurality of healthcare procedures including a type of healthcare procedure, and the hosted platform having program instructions residing on the one or more computer readable media and executable by processors further associated with the hosted platform to direct performance of operations comprising:
selectively initiating an interface between the hosted platform and at least one of the one or more client computing devices, the at least one of the one or more client computing devices associated with a first healthcare provider, wherein the first healthcare provider is associated with a patient and a respective healthcare procedure;
establishing a data module for the patient in the one or more non-transitory computer readable media, based at least in part on input data provided via the selectively initiated interface, wherein the input data comprises projected cost data for at least one aspect associated with the first healthcare provider for the respective healthcare procedure;
selectively initiating respective interfaces between the hosted platform and another of the one or more client computing devices associated with one or more further healthcare providers, wherein each respective interface with the one or more further healthcare providers is configured to receive input data comprising projected cost data for at least one aspect associated with the respective healthcare provider for the respective healthcare procedure; and
upon determining that a threshold amount of cost data has been received via the interfaces for each of the different aspects of the respective healthcare procedure, generating a message to the patient enabling selective access to an aggregated cost projection for the respective healthcare procedure, wherein the aggregated cost projection is based entirely on the input data received by the hosted platform for the respective healthcare procedure.

16. The hosted platform of claim 15, wherein the one or more further healthcare providers are invited via the hosted platform to establish respective interfaces with the hosted platform pursuant to selection by the first healthcare provider.

17. The hosted platform of claim 15, wherein the one or more further healthcare providers are invited to establish respective interfaces with the hosted platform pursuant to programmatic selection by the hosted platform based on predetermined relationships between the at least one of the one or more further healthcare providers and the at least one aspect for the respective healthcare procedure.

18. The hosted platform of claim 15, wherein the interface between the hosted platform and the first healthcare provider is selectively initiated pursuant to input from the first healthcare provider.

19. The hosted platform of claim 15, wherein the interface between the hosted platform and the first healthcare provider is selectively initiated pursuant to input from the patient.

20. A computer-implemented method for generating objective projections of aggregate costs from a plurality of providers associated with different aspects of a healthcare procedure, the method comprising:
providing, via a selectively initiated interface between a hosted platform and a first healthcare provider associated with a patient and a respective healthcare procedure, input data to a data module established in a data storage of the hosted platform, the data storage configured to store at least cost data corresponding to different aspects for each of a plurality of healthcare procedures including a type of healthcare procedure corresponding to the respective healthcare procedure;
forming a first input data set in a first data structure based upon the input data provided to the data module, the input data comprising projected cost data for at least one aspect associated with the first healthcare provider for the respective healthcare procedure, and further forming one or more further input data sets in respective one or more data structures, the one or more further data sets comprising historical cost data corresponding to the different aspects for each of the plurality of healthcare procedures including the type of healthcare procedure corresponding to the respective healthcare procedure, the historical data residing on the data module established in the data storage of the hosted platform;
mapping the first data structure against the respective one or more data structures to yield an aggregated cost projection for the respective healthcare procedure; and
upon determining that a threshold amount of cost data has been mapped for each of the different aspects of the respective healthcare procedure, generating a message to the patient enabling selective access to the aggregated cost projection for the respective healthcare procedure.
